(19) United States
(12) Patent Application Publication
(10) Pub. No.: US 2026/0121010 A1
(43) Pub. Date: Apr. 30, 2026

(54) CRYSTALLINE GRAPHITE SUBSTRATE AND MEASURING DEVICE USING CRYSTALLINE GRAPHITE SUBSTRATE

(71) Applicant: Panasonic Holdings Corporation, Osaka (JP)

(72) Inventors: NAOMI NISHIKI, Kyoto (JP); RYOU KUWABARA, Osaka (JP); TAKASHI TSURUTA, Osaka (JP); KOSO MATSUNO, Osaka (JP); TOSHIRO MATSUI, Fukuoka (JP); MITSURU TANAKA, Fukuoka (JP); KEISHIRO ARIMA, Kagoshima (JP)

(21) Appl. No.: 19/422,526

(22) Filed: Dec. 17, 2025

Related U.S. Application Data
(63) Continuation of application No. PCT/JP2024/017345, filed on May 10, 2024.

(30) Foreign Application Priority Data
Jun. 26, 2023 (JP) 2023-104410

(51) Int. Cl. H01J 49/16; C01B 32/205

(52) U.S. Cl. CPC H01J 49/164; C01B 32/205; C01P 2002/76; C01P 2004/03; C01P 2006/80; C01P 2006/90

(57) ABSTRACT

A crystalline graphite substrate having a carbon purity of 95% or more, in which a surface roughness Ra is from 1 μm to 8 μm inclusive, and a FWHM for a peak in X-ray diffraction corresponding to a layer interval at which hexagonal mesh structures in which six-membered rings of carbon atoms are continuous are stacked is from 3.5 degrees to 9 degrees inclusive.

### TECHNICAL FIELD

The present disclosure relates to a crystalline graphite substrate, and particularly to a measuring device using the crystalline graphite substrate for a portion for ionizing a measurement object in laser desorption ionization which is widely used for analyzing molecules such as proteins, peptides, and organic compounds.

### BACKGROUND ART

Mass spectrometry by matrix-assisted laser desorption ionization (MALDI) is performed by ionizing relatively high-molecular-weight substances such as proteins (generally having a molecular weight of 10,000 or more) and peptides (generally having a molecular weight of 1000 or more). However, it is usually difficult to detect a molecule having a mass of 500 Da or less. That is, in this method, when a measurement object is ionized by a laser, energy of the laser is not directly received by the measurement object, but a matrix mixed in advance with the measurement object converts the laser energy into thermal energy, and the thermal energy is used as ionization energy of the measurement object. As a result, the measurement object can be ionized without being broken.

However, at this time, an amount that can be ionized without destroying the measurement object (or ionization efficiency) varies depending on factors such as a type of the measurement object and a type of the matrix. Thus, selection of the matrix, optimization of laser irradiation conditions, preparation conditions, and the like are required each time depending on the measurement object. In addition, it is assumed that the matrix is mixed with a liquid measurement object and then dried to be uniformly concentrated, but the matrix may not be uniformly concentrated depending on drying conditions and physicochemical properties of the measurement object and the matrix. Further, since a cluster-shape noise is generated in a low molecular weight region from the matrix in which the measurement object is mixed, it is difficult to detect a low molecular weight compound by a MALDI-MS using a matrix.

In order to solve the above problems, a measurement method without using a matrix has been devised, and various measurement substrates have been proposed. PTL 1 discloses an example in which a highly oriented graphite sheet is used for a measurement substrate and irregularities of 10 nm to 1 μm are present on a surface to suppress a decrease in detection accuracy. In addition, PTL 2 discloses that a graphite thin film can be formed on a measurement substrate to perform efficient ionization. Further, PTL 3 illustrates that efficient ionization can be performed by using a graphene sheet or a carbon nanowall.

### CITATION LIST

### Patent Literature

PTL 1: Unexamined Japanese Patent Publication No. 2014-232055
PTL 2: Japanese Patent No. 5013421
PTL 3: Japanese Patent No. 5406621

### Non-Patent Literature

NPL 1: Synthesis and physical properties of pyrolytic graphite (IEEJ Trans, FM, Vol. 123, No. 11, pp 1115-1123, 2003)

### SUMMARY OF THE INVENTION

A crystalline graphite substrate according to an aspect of the present disclosure is a crystalline graphite substrate having a carbon purity of 95% or more, in which a surface roughness Ra is from 1 μm to 8 μm inclusive and a full width at half maximum (FWHM) for a peak in X-ray diffraction corresponding to a layer interval at which hexagonal mesh structures in which six-membered rings of carbon atoms are continuous are stacked is from 3.5 degrees to 9 degrees inclusive.

A method for manufacturing a crystalline graphite substrate according to another aspect of the present disclosure includes heating a polyimide film to 2500° C. or higher in an oxygen-free state to release hydrogen, oxygen, and nitrogen, and then recrystallizing remaining carbon atoms to provide a crystalline graphite substrate having a layered shape in which hexagonal mesh structures in which six-membered rings of carbon atoms are continuous are stacked, and applying a pressing pressure of 0.5 MPa to 10 MPa to the crystalline graphite substrate.

### BRIEF DESCRIPTION OF THE DRAWINGS

FIG. 1 is an SEM photograph showing a state of a surface of a crystalline graphite substrate according to a first exemplary embodiment.

FIG. 2 is a schematic view illustrating a crystal structure of the crystalline graphite substrate according to the first exemplary embodiment.

FIG. 3 is a schematic view illustrating an example of a distribution state of a measurement object before (a) and after (b) pressing for homogenizing a surface state of the crystalline graphite substrate.

FIG. 4 are a plan view (a) and a sectional view (b) illustrating a configuration of a measuring device in which the crystalline graphite substrate according to the first exemplary embodiment is used for a portion on which a measurement object is mounted.

FIG. 5 is Table 1 representing evaluation results in Examples and Comparative Examples.

FIG. 6 is a graph representing a relationship between an apparent density and a detection intensity of the crystalline graphite substrate.

FIG. 7 is a graph representing a relationship between a FWHM of an X-ray diffraction peak corresponding to a layer interval at which hexagonal mesh structures in which six-membered rings of carbon atoms are continuous are stacked in the crystalline graphite substrate and a detection intensity.

FIG. 8 is a graph representing a relationship between surface roughness Ra and a detection intensity of the crystalline graphite substrate.

### DESCRIPTION OF EMBODIMENT

An object of the present disclosure is to provide a crystalline graphite substrate that can be used in a measuring device capable of minimizing a decrease in detection accuracy without using a matrix in laser desorption ionization.

A crystalline graphite substrate according to a first aspect is a crystalline graphite substrate having a carbon purity of 95% or more, in which a surface roughness Ra is from 1 μm to 8 μm inclusive and a full width at half maximum (FWHM) for a peak in X-ray diffraction corresponding to a layer interval at which hexagonal mesh structures in which six-membered rings of carbon atoms are continuous are stacked is from 3.5 degrees to 9 degrees inclusive.

In the first aspect, a crystalline graphite substrate according to a second aspect may have a thickness of from 0.05 mm to 3 mm.

In the first or second aspect, a crystalline graphite substrate according to a third aspect may have an apparent density may be from 0.5 to 1.5 inclusive.

A measuring device according to a fourth aspect is a measuring device that mounts a measurement object in laser desorption ionization, the measuring device comprising the crystalline graphite substrate according to any one of the first to third aspects is used for a portion on which a measurement object to be ionized is mounted, wherein the crystalline graphite substrate is held by applying a tensile force from surroundings in a case where the crystalline graphite substrate has a thickness of 0.5 mm or less.

A method for manufacturing a crystalline graphite substrate according to a fifth aspect includes heating a polyimide film to 2500° C. or higher in an oxygen-free state to release hydrogen, oxygen, and nitrogen, and then recrystallizing remaining carbon atoms to provide a crystalline graphite substrate having a layered shape in which hexagonal mesh structures in which six-membered rings of carbon atoms are continuous are stacked, and applying a pressing pressure of 0.5 MPa to 10 MPa to the crystalline graphite substrate.

In the fifth aspect, in a method for manufacturing a crystalline graphite substrate according to a sixth aspect, in the heating of the polyimide film, a temperature raising rate to 1300° C. may be set to 7° C./min to 13° C./min, a temperature raising rate from 1300° C. to 2200° C. may be set to 4.9° C./min to 9.1° C./min, and a temperature raising rate at 2200° C. or higher may be set to 3.5° C./min to 6.5° C./min.

The crystalline graphite substrate according to the aspect of the present disclosure has high thermal conductivity in a basal in-plane direction. Due to this characteristics, in the case of being used in the measuring device on which the measurement object is mounted in laser desorption ionization, thermal energy generated by laser irradiation is more quickly diffused, and thermal energy at a laser irradiation location becomes uniform. In addition, the surface has the uniform surface state where the surface roughness is in the above range, and the FWHM of the X-ray diffraction peak corresponding to the layer interval at which the hexagonal mesh structures are stacked is in the above range. The measurement object is disposed in the recess of the surface, and thermal energy can be efficiently propagated. As a result, the ionization reaction of the measurement object is uniformly performed, detection accuracy is prevented from being lowered, and a detection width is widened from a low molecular weight region to a high molecular weight region. In addition, since the matrix material is unnecessary, effects such as shortening of a measurement preparation time and necessity of proficiency regarding the matrix are obtained.

Hereinafter, a crystalline graphite substrate according to an exemplary embodiment, a method for manufacturing the same, and a measuring device for use in laser desorption ionization using the crystalline graphite substrate will be described with reference to the accompanying drawings.

### First Exemplary Embodiment

### <Crystalline Graphite Substrate>

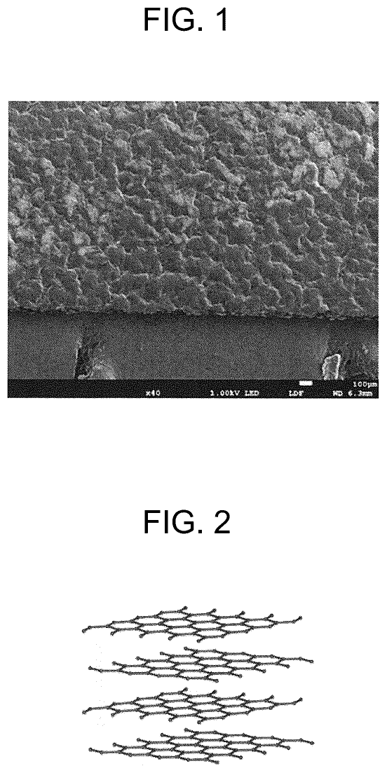

FIG. 1 is an SEM photograph showing a surface of a crystalline graphite substrate according to a first exemplary embodiment. FIG. 2 is a schematic view illustrating a crystal structure of the crystalline graphite substrate according to the first exemplary embodiment.

The crystalline graphite substrate according to the first exemplary embodiment is a crystalline graphite substrate having a carbon purity of 95% or more, preferably 99% or more. This crystalline graphite substrate has surface roughness Ra of from 1 μm to 8 μm inclusive. Surface roughness Ra be from 3 μm to 6 μm inclusive. A FWHM of a peak in X-ray diffraction corresponding to a layer interval at which hexagonal mesh structures in which six-membered rings of carbon atoms are continuous are stacked is from 3.5 degrees to 9 degrees inclusive. The FWHM may be from 5 degrees to 8 degrees inclusive.

Since the crystalline graphite substrate has flatness specified by surface roughness Ra and the FWHM, in the laser desorption ionization, in a case where the crystalline graphite substrate is used for a measuring device on which a measurement object is mounted, laser energy can be converted into thermal energy, and the thermal energy can be efficiently propagated to the measurement object.

In addition, the crystalline graphite substrate may have a thickness of from 0.05 mm to 3 mm inclusive. Further, an apparent density may be from 0.5 to 1.5 inclusive. In addition, the apparent density may be from 0.7 to 1.2 inclusive.

As illustrated in FIG. 1, the crystalline graphite substrate has an irregularity shape on a surface, specifically, has scale-shaped protrusion and recess.

As illustrated in FIG. 2, the crystalline graphite substrate according to the first exemplary embodiment has a layered shape in which hexagonal mesh structures in which six-membered rings of carbon atoms strongly connected by covalent bonds are joined are stacked. In other words, the crystalline graphite substrate has a multilayer structure including a plurality of hexagonal mesh layers stacked at intervals. The hexagonal mesh layer includes a plurality of six-membered rings covalently bonded by covalent bonds. The six-membered ring contains six carbon atoms. This crystalline graphite substrate has a carbon purity of 95% or more, preferably 99% or more. In addition, as will be described later, the reason why the FWHM of the peak in the X-ray diffraction corresponding to the layer interval at which the hexagonal mesh structures are stacked is less than or equal to 9 degrees is due to this crystal structure.

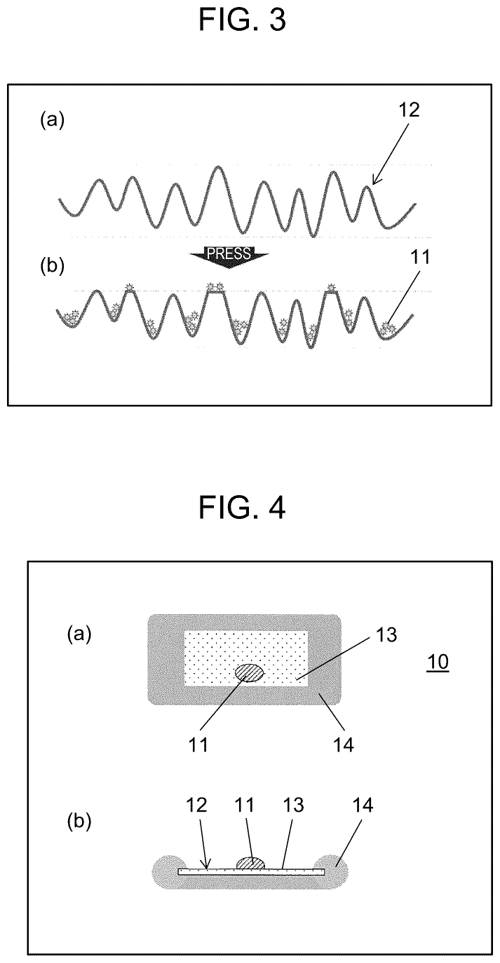

FIG. 3 is a schematic view illustrating examples of distribution states of a measurement object before (a) and after (b) pressing for homogenizing the surface of the crystalline graphite substrate. By this pressing, it is possible to correspond to a layer interval at which hexagonal mesh structures in which six-membered rings of carbon atoms are continuous are stacked, the hexagonal mesh structures having an apparent density of from 0.5 to 1.5 inclusive and surface roughness Ra of from 1 μm to 8 μm inclusive.

### <Measuring Device>

FIG. 4 is a plan view (a) and a sectional view (b) illustrating a configuration of measuring device 10 in which crystalline graphite substrate 13 according to the first exemplary embodiment is used for a portion on which measurement object 11 is mounted. In measuring device 10, crystalline graphite substrate 13 is used for the portion on which measurement object 11 is mounted, and a metal plate or a resin plate is used as holding material 14 for reinforcement and improvement of handleability. A basal plane of crystalline graphite substrate 13 is set to have a direction parallel to plane 12 on which measurement object 11 of measuring device 10 is mounted.

Note that, in a case where a thickness of the crystalline graphite substrate is small, since the surface may not maintain flatness, in a case where the thickness is less than or equal to 0.5 mm, the surface may be held by applying a tensile force from the surroundings. Accordingly, the flatness of the surface of the crystalline graphite substrate can be maintained.

In the laser desorption ionization, for example, about 0.5 μl of a solution containing measurement object 11 is dropped on crystalline graphite substrate 13 of measuring device 10, and the solution is evaporated and dried to fix measurement object 11 on crystalline graphite substrate 13. Measurement object 11 is irradiated with a laser to be ionized, and thus, a component is determined.

### <Method for Manufacturing Crystalline Graphite Substrate>

The crystalline graphite substrate according to the first exemplary embodiment can be manufactured by the following method.

(1) A specific resin material (for example, polyimide or the like) is heated to 2500° C. or higher in an oxygen-free state to release hydrogen, oxygen, and nitrogen, and then the remaining carbon atoms are recrystallized by heating to form a layered shape in which carbon atom hexagonal mesh structures are stacked (heating step) (see, for example, NPL 1). A surface state of the obtained crystalline graphite substrate can be changed by changing a temperature raising rate or maintaining a temperature at a high temperature in this case. Note that, heating may be performed to 3000° C. or higher.

(2) After the heating step, in order to homogenize the surface state, for example, the obtained crystalline graphite substrate is pressed at 2 MPa (pressurizing step). A pressing pressure may be, for example, 0.5 MPa to 10 MPa.

In the first exemplary embodiment, in the heating step, in consideration that temperatures at which hydrogen, oxygen, and nitrogen are released are different, heat treatment may be performed in an argon gas at a temperature raising rate of, for example, 10° C./min (7° C./min to 13° C./min) to 1300° C., at a temperature raising rate of, for example, 7° C./min (4.9° C./min to 9.1° C./min) from 1300° C. to 2200° C., and at a temperature raising rate of, for example, 5° C./min (3.5° C./min to 6.5° C./min) at 2200° C. or higher. The temperature raising rate is preferably controlled within ±30%. Note that, the two temperatures of 1300° C. and 2200° C. have been mentioned as the temperatures at which the temperature raising rate is changed, but the temperature raising rate may not be strictly changed at these temperatures. For example, the temperature may be changed in a range of about 100° C. in a range of ±50° C. around these temperatures. In addition, the temperature raising rate is not limited to a change accompanied by a numerical value jump, and may be gradually changed, for example, continuously changed. Further, the temperature raising rate may not be maintained constant, and may be changed within the above range.

How a measurement substrate for mass spectrometry acts in the measuring device according to the present exemplary embodiment will be described. In a laser desorption ionization mass spectrometer targeted by the measuring device according to the present exemplary embodiment, the measurement object is placed on the measuring device, laser irradiation is performed, and the measurement object is ionized by the generated thermal energy. This basic mechanism is widely known as matrix-assisted laser desorption ionization or soft laser desorption ionization. The generated ions of the measurement object are emitted and accelerated from the measuring device, fly a predetermined distance between electrodes in the device, and then detected by a detector. A time-of-flight is measured, and thus, a mass of the generated ions can be known to specify the component. Note that, there is also a method for measuring the mass of the ions by a method other than the time-of-flight measurement.

In matrix-assisted laser desorption ionization using a matrix material, laser energy is converted into thermal energy in a matrix, and a temperature at an irradiation point is raised. The measurement object is sublimated from a solid to a gas in a procedure of the temperature rise, and at the same time, some H⁺ ions (=protons) of a matrix substance move to the measurement object, and thus, the measurement object is ionized.

On the other hand, in the measuring device for use in the laser desorption ionization according to the present disclosure, the crystalline graphite substrate on which the measurement object is mounted absorbs the laser energy and converts the laser energy into thermal energy. As a result, the temperature at the irradiation point is raised, and the measurement object is sublimated. At this time, Na⁺ ions are added to the measurement object in a positive ion mode, and H⁺ is desorbed from the measurement object in a negative ion mode. As a result, the measurement object is ionized.

Measurement conditions were as follows, and comparison was made in the negative mode. However, a similar result can be acquired in the positive mode.
Measurement object: histidine
Amount of measurement object: 50 pmol/0.5 μl-spot
Laser desorption ionization mass spectrometer: AutoFlex III (manufactured by Bruker Daltonics)
Measurement range: 0-2000 m/z
Laser irradiation condition: wavelength 355 nm (Nd: YAG), 100 shots/pixel

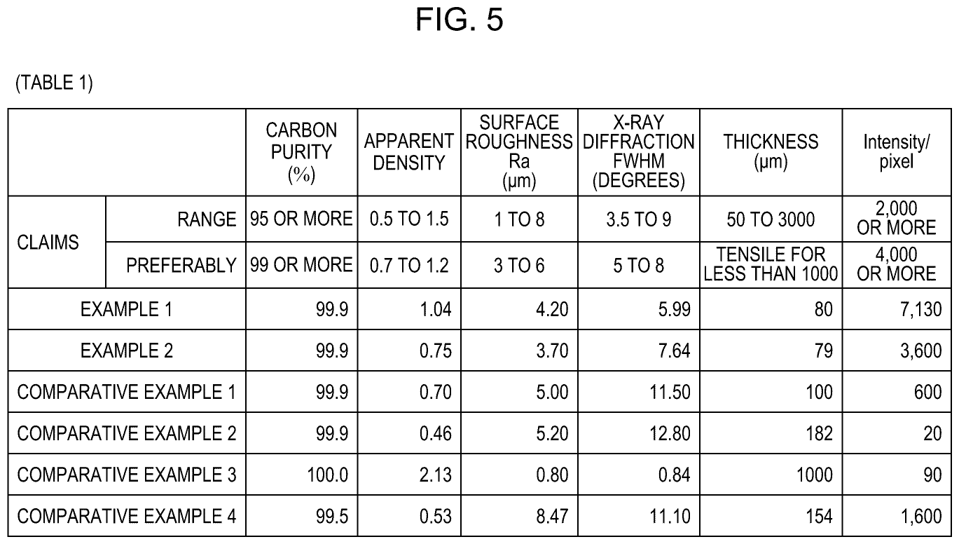

In order to be used as the measuring device, detection intensity intensity/pixel may be more than or equal to 2000, and preferably more than or equal to 4000. Examples and Comparative Examples are illustrated below. FIG. 5 is Table 1 of a list of evaluation results in Examples and Comparative Examples.

### Example 1

A crystalline graphite substrate was obtained by performing a heat treatment on a polyimide film in an argon gas at a temperature raising rate of 10° C./min to 1300° C., at a temperature raising rate of 7° C./min from 1300° C. to 2200° C., at 5° C./min at 2200° C. or higher, and up to 3000° C., and then pressing the polyimide film at 3 MPa. This crystalline graphite substrate had an apparent density of 1.04, a surface roughness of 4.2 μm, and a FWHM of 5.99 degrees for a peak in X-ray diffraction corresponding to a layer interval at which hexagonal mesh structures in which six-membered rings of carbon atoms were continuous were stacked. The crystalline graphite substrate having a size of 40 mm×20 mm×a thickness of 80 μm was measured under the above-described conditions by using a matrix-assisted laser desorption ionization mass spectrometer as a measuring device used for a portion on which a measurement object to be ionized was mounted. As a result, an intensity/pixel of 7130 was obtained. It can be seen that the obtained detection intensity is relatively high and can be sufficiently used as a measuring device.

### Example 2

A crystalline graphite substrate was obtained by performing a heat treatment on a polyimide film in an argon gas at a temperature raising rate of 10° C./min to 1300° C., at a temperature raising rate of 8° C./min from 1300° C. to 2200° C., at 4° C./min at 2200° C. or higher, and up to 3000° C., and then pressing the polyimide film at 1 MPa. This crystalline graphite substrate had an apparent density of 0.75, a surface roughness of 3.7 μm, and a FWHM of 7.64 degrees for a peak in X-ray diffraction corresponding to a layer interval at which hexagonal mesh structures in which six-membered rings of carbon atoms were continuous were stacked. The crystalline graphite substrate having a size of 40 mm×20 mm×a thickness of 79 μm was measured under the above-described conditions by using a matrix-assisted laser desorption ionization mass spectrometer as a measuring device used for a portion on which a measurement object to be ionized was mounted. As a result, an intensity/pixel of 3600 was obtained. It can be seen that the obtained detection intensity is relatively high and can be used as a measuring device.

### Comparative Example 1

A crystalline graphite substrate was obtained by performing a heat treatment on a polyimide film in an argon gas at a temperature raising rate of 10° C./min to 1300° C., at a temperature raising rate of 4° C./min from 1300° C. to 2200° C., at 8° C./min at 2200° C. or higher, and up to 3000° C., and then pressing the polyimide film at 3 MPa. This crystalline graphite substrate had an apparent density of 0.70, a surface roughness of 5 μm, and a FWHM of 11.5 degrees for a peak in X-ray diffraction corresponding to a layer interval at which hexagonal mesh structures in which six-membered rings of carbon atoms were continuous were stacked. The crystalline graphite substrate having a size of 40 mm×20 mm×a thickness of 100 μm was measured under the above-described conditions by using a matrix-assisted laser desorption ionization mass spectrometer as a measuring device used for a portion on which a measurement object to be ionized was mounted. As a result, an intensity/pixel of 600 was obtained. It can be seen that the obtained detection intensity is a relatively low intensity, is not sufficient, and cannot be used as a measuring device.

### Comparative Example 2

A crystalline graphite substrate was obtained by performing a heat treatment on a polyimide film in an argon gas at a temperature raising rate of 10° C./min to 1300° C., at a temperature raising rate of 10° C./min from 1300° C. to 2200° C., at 3° C./min at 2200° C. or higher, and up to 3000° C., and then pressing the polyimide film at 3 MPa. This crystalline graphite substrate had an apparent density of 0.46, a surface roughness of 5.2 μm, and a FWHM of 12.8 degrees for a peak in X-ray diffraction corresponding to a layer interval at which hexagonal mesh structures in which six-membered rings of carbon atoms were continuous were stacked. The crystalline graphite substrate having a size of 40 mm×20 mm×a thickness of 182 μm was measured under the above-described conditions by using a matrix-assisted laser desorption ionization mass spectrometer as a measuring device used for a portion on which a measurement object to be ionized was mounted. As a result, an intensity/pixel of 20 was obtained. It can be seen that the obtained detection intensity is a relatively low intensity, is not sufficient, and cannot be used as a measuring device.

### Comparative Example 3

A crystalline graphite substrate was obtained by performing a heat treatment on a polyimide film in an argon gas at a temperature raising rate of 6° C./min to 1300° C., at a temperature raising rate of 4° C./min from 1300° C. to 2200° C., at 3° C./min at 2200° C. or higher, and up to 3000° C., and then pressing the polyimide film at 3 MPa. This crystalline graphite substrate had an apparent density of 2.13, a surface roughness of 0.8 μm, and a FWHM of 0.84 degrees for a peak in X-ray diffraction corresponding to a layer interval at which hexagonal mesh structures in which six-membered rings of carbon atoms were continuous were stacked. The crystalline graphite substrate having a size of 40 mm×20 mm×1 mm in thickness was measured under the above-described conditions by using a matrix-assisted laser desorption ionization mass spectrometer as a measuring device used for a portion on which a measurement object to be ionized was mounted. As a result, an intensity/pixel of 90 was obtained. It can be seen that the obtained detection intensity is a relatively low intensity, is not sufficient, and cannot be used as a measuring device.

### Comparative Example 4

A crystalline graphite substrate was obtained by performing a heat treatment on a polyimide film in an argon gas at a temperature raising rate of 14° C./min to 1300° C., at a temperature raising rate of 10° C./min from 1300° C. to 2200° C., at 8° C./min at 2200° C. or higher, and up to 3000° C., and then pressing the polyimide film at 10 MPa. The crystalline graphite substrate had an apparent density of 0.53, a surface roughness of 8.47 μm, and a FWHM of 11.1 degrees for a peak in X-ray diffraction corresponding to a layer interval at which hexagonal mesh structures in which six-membered rings of carbon atoms were continuous were stacked. The crystalline graphite substrate having a size of 40 mm×20 mm×a thickness of 154 μm was measured under the above-described conditions by using a matrix-assisted laser desorption ionization mass spectrometer as a measuring device used for a portion on which a measurement object to be ionized was mounted. As a result, an intensity/pixel of 1600 was obtained. It can be seen that the obtained detection intensity is a relatively low intensity, is not sufficient, and cannot be used as a measuring device.

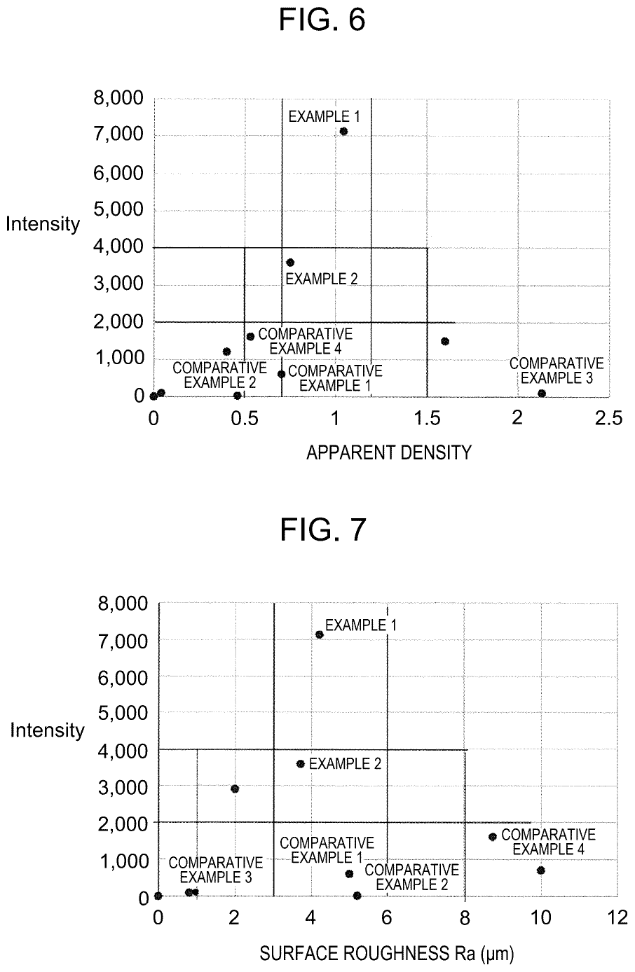

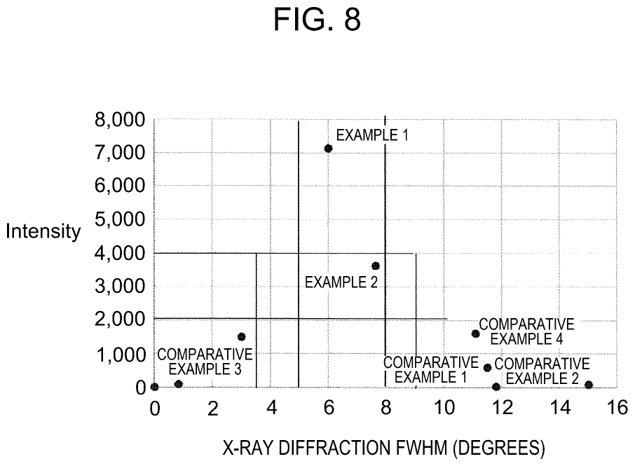

FIG. 6 is a graph representing the relationship between the apparent density and the detection intensity of the crystalline graphite substrate. FIG. 7 is a graph representing a relationship between a FWHM of an X-ray diffraction peak corresponding to a layer interval at which hexagonal mesh structures in which six-membered rings of carbon atoms are continuous are stacked in a crystalline graphite substrate and a detection intensity. FIG. 8 is a graph representing the relationship between surface roughness Ra of the crystalline graphite substrate and the detection intensity.

In FIGS. 6 to 8, evaluation results including Examples 1 and 2 and Comparative Examples 1 to 4 are plotted.

As illustrated in FIG. 6, the apparent density of the crystalline graphite substrate having a detection intensity of 2000 or more is from 0.5 to 1.5 inclusive.

As illustrated in FIG. 7, the FWHM of the X-ray diffraction peak corresponding to the layer interval at which the hexagonal mesh structures in which the six-membered rings of the carbon atoms are continuous are stacked in the crystalline graphite substrate having a detection intensity of 2000 or more is from 3.5 degrees to 9 degrees inclusive.

As illustrated in FIG. 8, surface roughness Ra of the crystalline graphite substrate having a detection intensity of 2000 or more is from 1 μm to 8 μm inclusive.

### INDUSTRIAL APPLICABILITY

According to the crystalline graphite substrate according to the present disclosure, in the laser desorption ionization, it is possible to minimize a decrease in detection accuracy without using a matrix by using the crystalline graphite substrate for the measuring device on which the measurement object is mounted.

### REFERENCE MARKS IN THE DRAWINGS

10 measuring device
11 measurement object
12 surface of crystalline graphite substrate
13 crystalline graphite substrate
14 holding material

1. A crystalline graphite substrate having a carbon purity of 95% or more, in which
a surface roughness Ra is from 1 μm to 8 μm inclusive, and
a full width at half maximum (FWHM) for a peak in X-ray diffraction corresponding to a layer interval at which hexagonal mesh structures in which six-membered rings of carbon atoms are continuous are stacked is from 3.5 degrees to 9 degrees inclusive.

2. The crystalline graphite substrate according to claim 1, wherein a thickness of the crystalline graphite substrate is from 0.05 mm to 3 mm inclusive.

3. The crystalline graphite substrate according to claim 1, wherein an apparent density of the crystalline graphite substrate is from 0.5 to 1.5 inclusive.

4. A measuring device that mounts a measurement object in laser desorption ionization, the measuring device comprising:
the crystalline graphite substrate according to claim 1 for a portion on which a measurement object to be ionized is mounted, wherein
the crystalline graphite substrate is held by applying a tensile force from surroundings in a case where the crystalline graphite substrate has a thickness of 0.5 mm or less.

5. A method for manufacturing a crystalline graphite substrate, the method comprising:
heating a polyimide film to 2500° C. or higher in an oxygen-free state to release hydrogen, oxygen, and nitrogen, and then recrystallizing remaining carbon atoms to provide a crystalline graphite substrate having a layered shape in which hexagonal mesh structures in which six-membered rings of carbon atoms are continuous are stacked; and
applying a pressing pressure of 0.5 MPa to 10 MPa to the crystalline graphite substrate.

6. The method according to claim 5, wherein, in the heating of the polyimide film, a temperature raising rate to 1300° C. is set to 7° C./min to 13° C./min, a temperature raising rate from 1300° C. to 2200° C. is set to 4.9° C./min to 9.1° C./min, and a temperature raising rate at 2200° C. or higher is set to 3.5° C./min to 6.5° C./min.
